(19) United States
(12) Patent Application Publication
(10) Pub. No.: US 2011/0156564 A1
(43) Pub. Date: Jun. 30, 2011

(54) SPACE EFFICIENT MULTI-FUNCTION KITCHEN APPLIANCE

(75) Inventor: Nojae PARK, Chiba Prefecture (KR)

(73) Assignee: Aktiebolaget Electrolux, Stockholm (SE)

(21) Appl. No.: 12/977,863

(22) Filed: Dec. 23, 2010

Related U.S. Application Data
(63) Continuation-in-part of application No. PCT/SE2009/000322, filed on Jun. 23, 2009.

(30) Foreign Application Priority Data
Jun. 24, 2008 (SE) 0801.481-3

(51) Int. Cl. A47B 77/02; F25D 23/00; A47J 37/00; A47B 81/04

(52) U.S. Cl. 312/403; 312/352

(57) ABSTRACT

A space efficient multi-function kitchen appliance including a number of compartments. The compartments are vertically superimposed with respect to each other and can include serving tray, a cooking compartment, a storage compartment, and a refrigeration compartment. If desired, each compartment can be slidably coupled to a frame to function as discrete drawers. The cooking drawer can include a control switch that is pivotally movable between a horizontal position and a raised position so that the closing of the cooking drawer automatically turns off the cooking device. The storage drawer can be located between the cooking drawer and the refrigeration drawer to buffer the changes in temperature between the refrigeration compartment and the cooking compartment. The refrigeration drawer and the storage drawer can each be complementary stepped to have different heights on their left and right sides to maximize storage functionality. The tray drawer may be located above the cooking drawer and its tray may absorb heat from the cooking area to serve as a warm serving tray. The space efficient multi-function kitchen appliance preferably also includes wheels to help maximize usage of the appliance in small living areas.

### CROSS REFERENCE TO RELATED APPLICATION

This application is a continuation-in-part of International Application No. PCT/SE2009/000322 filed Jun. 23, 2009 entitled CABINET KITCHEN, which claims priority from Swedish Application No. 0801.481-3 filed Jun. 24, 2008 entitled CABINET KITCHEN, the entire contents of both are incorporated herein by reference.

### FIELD

The disclosure relates to a space-efficient multi-function kitchen appliance that includes at least one station for cooking and another station for refrigeration.

### BACKGROUND

Many people live in small and/or cramped living quarters. In such case, the priority of eating self-cooked foods is not that high. Additionally, they also commonly do not want to move when they are working or watching a television monitor but at the same time they are hungry.

### BRIEF SUMMARY

Aspects of the current disclosure pertain to a cabinet kitchen having a cooking drawer and a refrigeration drawer.

According to another aspect, a multi-function kitchen appliance includes first, second, and third compartments that are vertically superimposed with respect to each other.

According to another aspect, a cabinet kitchen includes a frame, a plurality of wheels, a tray, a cooking device, a storage compartment, and a refrigeration compartment. The wheels are mounted to a lower side of the frame. The tray may be slidably mounted to the frame for movement within a first position nested within the frame and a second position at least partially extending from the frame. The cooking device may be slidably mounted to the frame for movement within a first position nested within the frame and a second position at least partially extending from the frame. The storage compartment may be slidably mounted to the frame for movement within a first position nested within the frame and a second position at least partially extending from the frame. The cooking device is mounted to the frame below the tray, the storage compartment device may be mounted to the frame below the tray and the cooking device, and the refrigeration compartment may be mounted to the frame below the storage compartment.

These and other aspect of the disclosure will be evident from a review of the written disclosure and the related drawings.

### BRIEF DESCRIPTION OF THE DRAWINGS

The foregoing summary as well as the following detailed description, considered in conjunction with the accompanying drawings, provide a better understanding, in which like reference numbers refer to like elements, and wherein:

FIG. 1 is a perspective view of a cabinet kitchen with a cooking drawer in an open position;

FIG. 2 is a front view of the cabinet kitchen with the drawers in their closed positions and showing some of the internal elements in dashed lines;

FIGS. 3A and 3B are perspective and top plan views of the cabinet kitchen with an tray drawer in an open position;

FIGS. 4A and 4B are perspective and top plan views of the cabinet kitchen with the cooking drawer in an open position;

FIGS. 5A and 5B are perspective and top plan views of the cabinet kitchen with a storage drawer in an open position;

FIGS. 6A and 6B are perspective and top plan views of the cabinet kitchen with a refrigeration drawer in an open position;

FIG. 7 is an enlarged perspective view of a detail of the cooking drawer;

FIG. 8 is an enlarged perspective view of the detail of the cooking drawer as the cooking drawing is being moved into its closed position;

FIG. 9 is an enlarged perspective view of the storage drawer;

FIG. 10 is a schematic view of a drawer divider; and

FIG. 11 is a schematic diagram illustrating from side view the temperature transfer characteristics associated with the cabinet kitchen.

### DETAILED DESCRIPTION

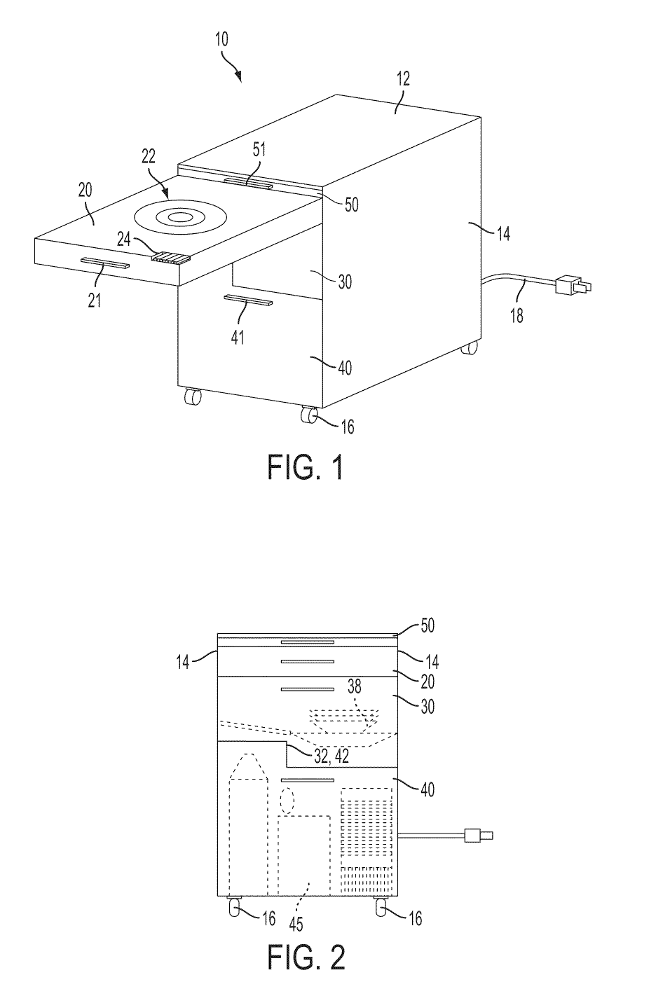

FIGS. 1-11 illustrate details of a space efficient multi-function kitchen appliance referred to herein as a cabinet kitchen 10 according to an embodiment of the disclosure. According to the embodiment, the cabinet kitchen 10 includes a plurality of discrete compartments to enable the kitchen cabinet 10 to serve as a multi-function appliance for storage of cooking and/or eating utensils, a refrigeration device for storage and refrigeration of foods, a cooking device for cooking the foods, and a tray for serving and eating the prepared foods and for other functions. Accordingly, these compartments include a serving tray, a cooking compartment, a storage compartment, and a refrigeration compartment.

As can schematically be seen in FIG. 1, the cabinet kitchen 10 includes a rectangular cabinet frame includes a top surface 12 and opposed side surfaces 14 that contain compartments therein. In the depicted embodiment, the compartments are defined by discrete drawers 20, 30, 40, and 50. The cabinet kitchen 10 also has a plurality of wheels 16 on the bottom. This enables the cabinet kitchen 10 to be easily wheeled to convenient locations for eating, cooking, and/or storage purposes. A power cord 18 is coupled to the cabinet kitchen 10 to supply power to the cabinet kitchen for cooking and refrigeration purposes.

The drawers 20, 30, 40, and 50 are vertically superimposed with respect to each other in the cabinet kitchen 10. Each of the drawers 20, 30, 40, and 50 include respective handles 21, 31, 41, and 51 schematically represented in the figures. Any desirable shape and configuration can be used for the handles 21, 31, 41, and 51. The handles 21, 31, 41, and 51 facilitate the opening and closing of the drawers 20, 30, 40, and 50 (and the movement of the drawers 20, 30, 40, and 50 between respective closed and extended positions). The drawers 20, 30, 40, and 50 are individually slidably coupled to the frame of the cabinet kitchen 10 by any desirable drawer-type coupling system. FIG. 1 schematically represents one part of a slide system, e.g., slide 29, 39, 49, and 59, for each respective drawer 20, 30, 40, and 50. It is recognized that a mating part would be included on the inside of the frame to facilitate the sliding coupling.

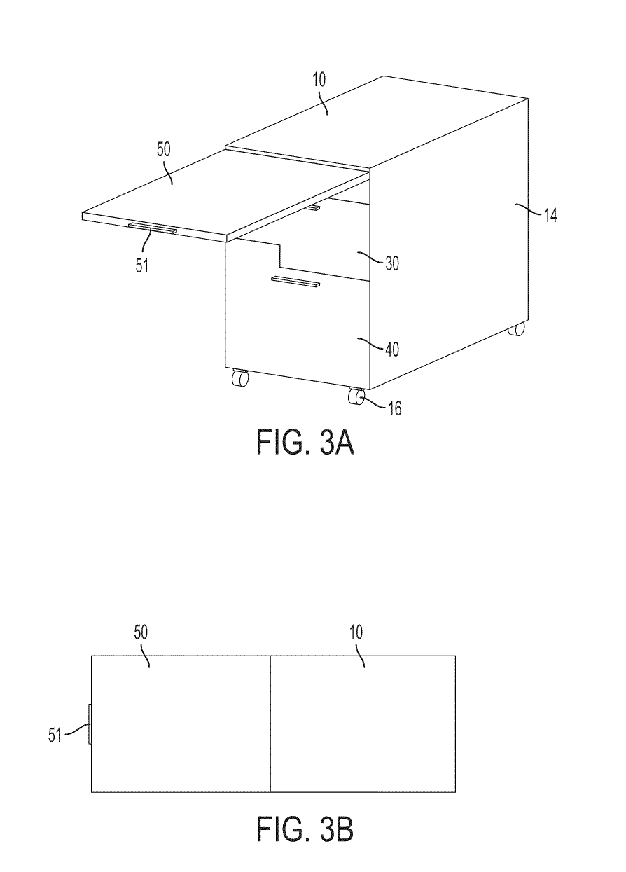

The drawers 20, 30, 40, and 50 of the cabinet kitchen 10 include, from top to bottom, a tray drawer 50, a cooking drawer 20, a storage drawer 30, and a refrigeration drawer 40. FIGS. 3A and 3B depict the tray drawer 50 in an open position. The tray drawer 50 slides out to expose a substantially planar surface 52. This planar surface 52 may be used as a supporting tray for the user to eat his food if he so chooses. It is also recognized that the planar surface 52 may be used to rest other articles based on the user's living preferences. In one embodiment, the tray drawer 50 is made from a stainless steel to help provide desired heat transfer characteristics for the cabinet kitchen 10. That is, some residual heat from the cooking processing will inherently warm the planar surface 52 so the tray drawer 50 may also function as a warming tray.

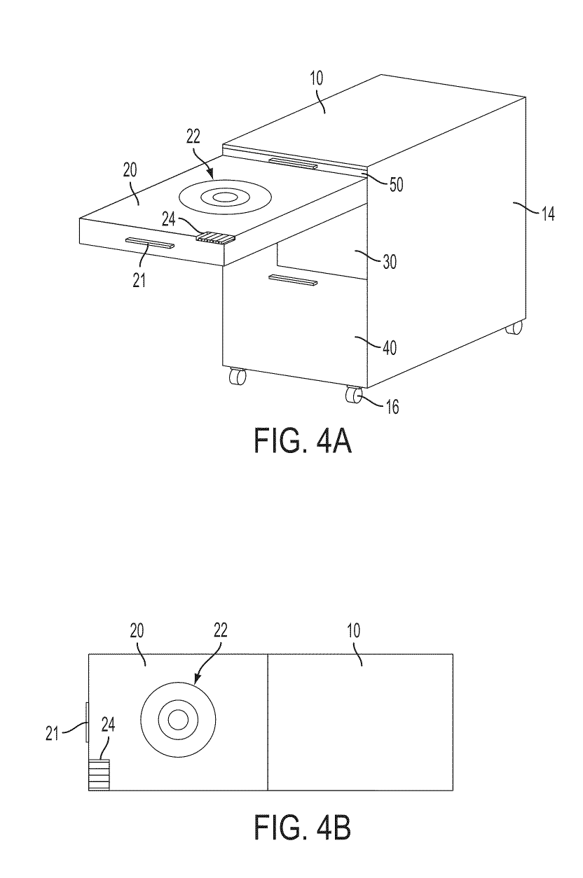

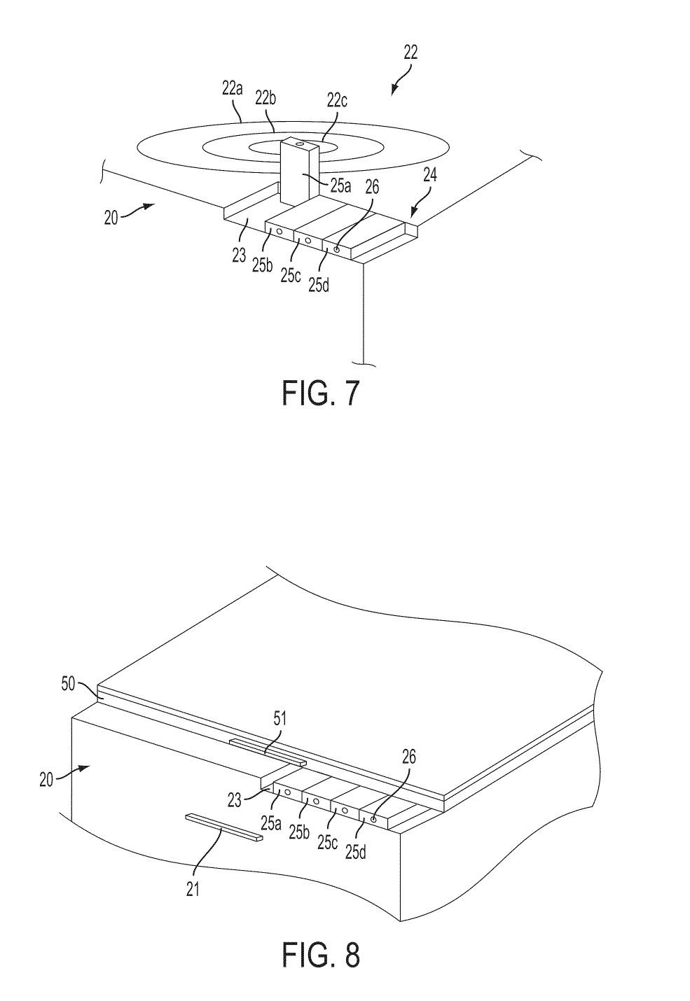

FIGS. 4A and 4B depict the cooking drawer 20 in an open position. Details of the cooking region and controls are best shown in FIGS. 7 and 8. With respect to FIGS. 7 and 8, the cooking area 22 including a plurality of cooking regions, for example cooking regions 22a, 22b, and 22c. Any desirable cooking system may be used. As examples, the cooking system can be an electric cooking system or an induction-based cooking system.

The controls 24 are located in a recess 23 associated with the surface containing the cooking area 22. More specifically, in the depicted embodiment, the controls 24 are located near the exposed front end of the cooking drawer 20. The controls include a plurality of switches 25a, 25b, 25c, and 25d. At least one of the switches affecting the ON/OFF power status to the cooking area 22 is pivotally coupled within the recess 24. When the switch 25a is in the horizontal position as is shown in FIG. 8, the cooking area 22 is OFF. When the switch is pivoted to an upward position, for example as is shown in FIG. 8, the cooking area 22 is ON. If the user moves the cooking drawer 20 to the closed position, the cabinet kitchen 10, and preferably the bottom of the front face of the tray drawer 50 inherently pushes the switch 25a to its horizontal position and automatically turns OFF the power to the cooking area 22 in the event the user had forgotten to manually switch it to OFF. Additionally, the vertical ON and horizontal OFF nature of this switch enables the user to easily turn the power to the cooking area 22 OFF by moving a cooking implement (such as a pan) to push the switch 25a down when the cooking implement is removed from the cooking area 22.

Further, if desired, the switch 25a can be a variable power switch and control not just ON/OFF, but also the level/intensity of the power/heat for the cooking area 22. For example, placing the switch 25a in a vertical position can be full power/heat, and placing the switch 25a in an intermediate position, such as 45° can be a medium power/heat, and placing the switch 25a in a horizontal position would turn the power/heat OFF.

The remainder of the controls 24 can be in any configuration. In one arrangement, there are additional switches 25b, 25c, and 25d that pivot similar to switch 25a. These switches 25b, 25c, and 25d can correspond to specific cooking regions 22a, 22b, 22c, etc. so that the user can select proper size of heat (e.g., size of the active cooking area) according to the size of the pot to be used. Indicia 26, such as increasing sizes of icons, on the front of the switches 25a, 25b, 25c, and/or 25d can correspond to the cooking regions 22a, 22b, 22c to make the selection of the appropriate cooking region more intuitive. Any desirable control configuration for the switches 22a, 25b, 25c, and 25d may be used. In one configuration, one switch, for example switch 25a, controls the power and the amount of heat, while the remaining switches 25b, 25c, and 25d control the selection of the size of the cooking area. In another arrangement, each switch 25a, 25b, 25c, and 25d would control the power to a designated cooking 22a, 22b, 22c. The number of cooking regions could correspond to the number of switches used. It is recognized that other control configuration s could be used within the spirit of the invention.

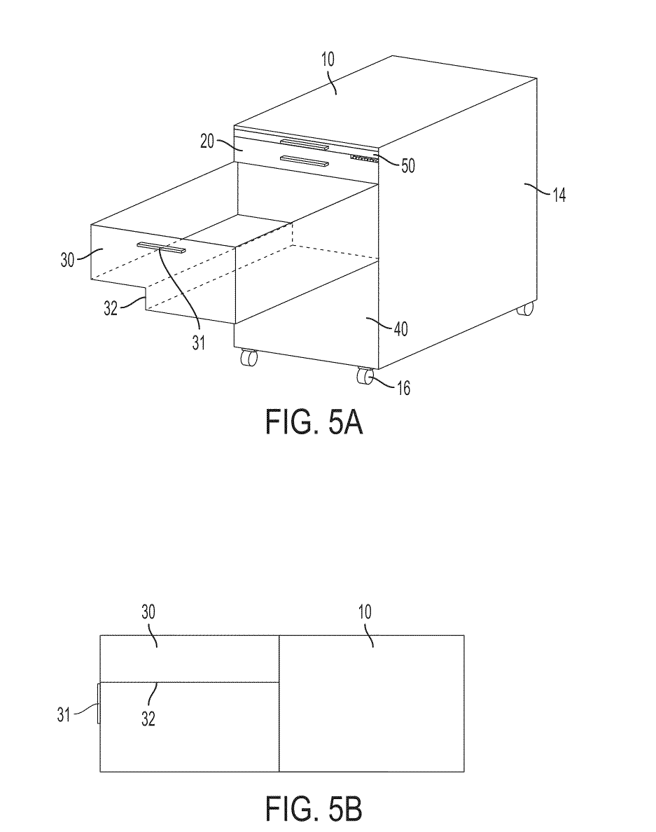

FIGS. 5A and 5B depict the storage drawer 30 in an open position. The storage drawer 30 is shown in its closed position in FIG. 2 and depicted with items 38 such as pots, pans, and dishes shown in dashed lines. As can be seen in the figures, the storage drawer 30 has a stepped bottom section 32 resulting in the height of the drawer being different on the left and right sides of the storage drawer 30. This facilitates the storage of many different cooking items like pans that have an elongated handle.

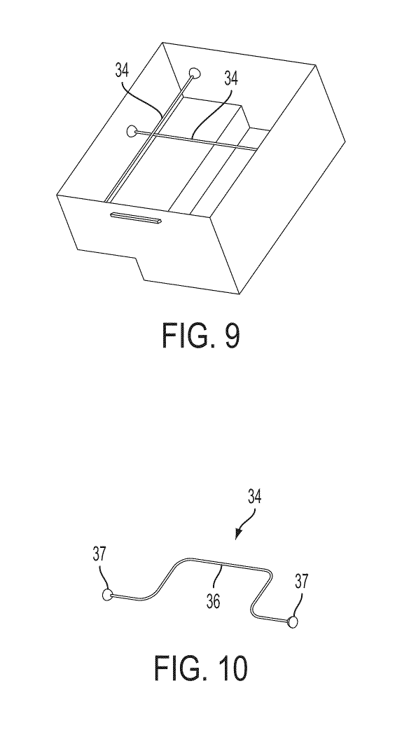

As shown in FIGS. 9 and 10, the storage drawer 30 includes a plurality of flexible drawer dividers 34. Each flexible divider 34 includes a flexible rubber element 36. Magnets 37 are affixed at the opposing ends of the flexible rubber element 36. The flexible dividers 34 enable the space inside the storage drawer 30 to be subdivided. This enables a more efficient use of the storage area by dividing the space to better accommodate the items to be stored, and also prevents items such as plates from excessive shifting and from possibly falling from the upper part to the lower part of the storage drawer 30. The storage drawer 30 or at least an interior portion of the storage drawer 30 is preferably made from a magnetic attractive material.

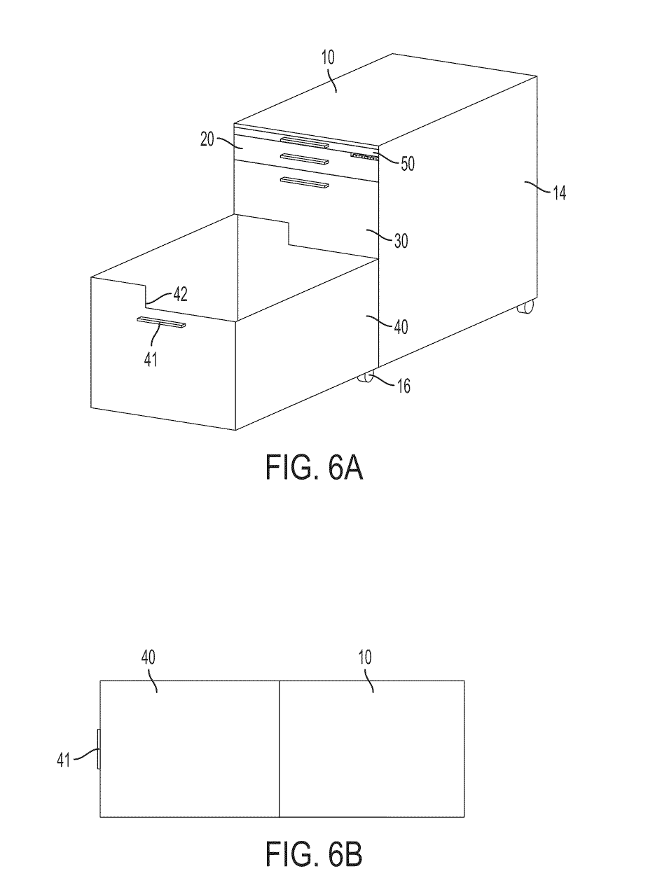

FIGS. 6A and 6B depict the refrigeration drawer 40 in an open position. The refrigeration drawer 40 is shown in its closed position in FIG. 2 and depicted with refrigerated food items 45 shown in dashed lines. As can be seen in the figures, the refrigeration drawer 40 has a stepped upper contour 42 resulting in the height of the refrigeration drawer being different on the left and right sides. This facilitates the storage of many different refrigerated food items like tall bottles where extra height may be needed. It can be seen that the difference in heights between the left and right sides of the storage drawer 30 and the refrigeration drawer 40 are complimentary to maximize storage attributes in both sections.

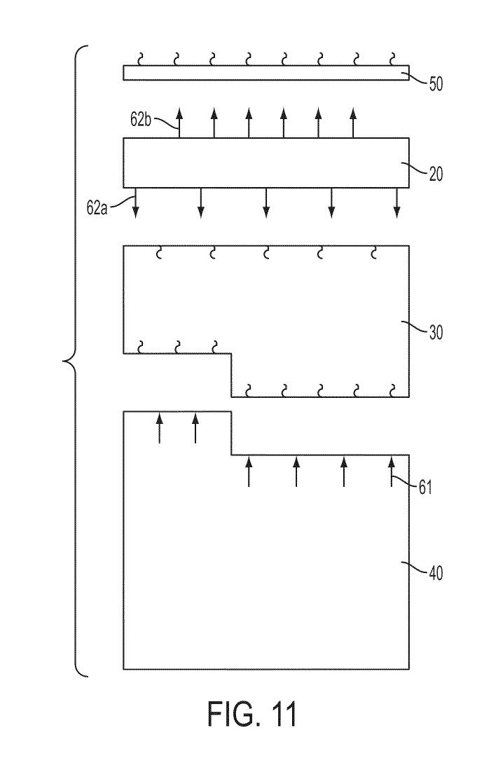

FIG. 11 schematically depicts temperature flow aspects of the cabinet kitchen 10. The cooking drawer 20 may have heat associated with its use. Heat from the cooking drawer 20 may dissipate upwardly as schematically shown by arrows 62b and may dissipate downwardly as schematically shown by arrows 62a. The planar surface 52 (e.g., the stainless tray) of the tray drawer 50 can partially absorb and make use of residual heat from the cooking drawer 20 to maintain the warmth of food served thereon if moved to an open position. The planar surface 52 also aids in cooling down the cabinet kitchen 10 after a cooking process as it temporarily absorbs remaining heat as it eventually dissipates into the ambient air.

The refrigeration drawer 30 may have cooler temperatures associated with its use as schematically represented by arrows 61. The storage drawer 30 being located between the cooking drawer 20 and the refrigeration drawer 40 serves as a temperature buffer zone between the heat and the cold so that heat from cooking drawer 20 and cold from the refrigeration drawer 40 do not meaningfully impact the other.

Accordingly, it can be seen the cabinet kitchen 10 and various aspects of it serve as a beneficial multi-appliance device. This is particularly true in small living spaces. It can serve as a device for storing foods in refrigerators and also for storing cooking-related utensils. It also provides the functionality to cook thereon with suitable controls and safety provisions. Additionally, it includes a slide out tray enabling the user to easily eat the cooked meal conveniently. As it is on wheels, it is mobile and can be moved to convenient locations.

It is recognized that alternative embodiments and configurations need not include all these drawers and/or may include additional drawers and/or the drawers may be in a different configuration. For example, one or more of the sections, such as the refrigeration section, need not be on sliding drawer system and could have a front access door if desired as is used for example on many small refrigerators.

While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention will include all embodiments falling within the scope of the appended claims.

What is claimed is:

1. A cabinet kitchen comprising a cooking drawer and a refrigeration drawer.

2. The cabinet kitchen according to claim 1, wherein the cabinet comprises a drawer for storing dishes.

3. The cabinet kitchen according to claim 2, wherein the storage drawer is disposed vertically between the cooking drawer and the refrigeration drawer, and the storage drawer, the cooking drawer, and the refrigeration drawer are vertically superimposed with respect to each other.

4. The cabinet kitchen according to claim 3, further comprising a flexible drawer divider disposed in the storage drawer wherein the drawer divider include a flexible element with magnets at opposing first and second ends.

5. The cabinet kitchen according to claim 3, wherein the bottom and the storage drawer and top of the refrigeration drawer are vertically stepped.

6. The cabinet kitchen according to claim 2, further comprising a plurality of wheels enabling the kitchen cabinet to rolled with respect to a supporting surface.

7. The cabinet kitchen according to claim 6, further comprising a tray drawer disposed above the cooking drawer having a flat upper surface.

8. The cabinet kitchen according to claim 7, wherein the storage drawer is disposed vertically between the cooking drawer and the refrigeration drawer, and the storage drawer, the cooking drawer, the refrigeration drawer, and the tray drawer are vertically superimposed with respect to each other.

9. The cabinet kitchen according to claim 1, wherein the cooking drawer includes an automatic shutoff switch wherein a cooking device is automatically shut off upon the closing of the cooking drawer.

10. The cabinet kitchen according to claim 9, wherein cooking drawer includes a cooking surface and a recess portion with respect to the cooking surface, and the automatic shut off switch is pivotally mounted in the recess and is pivotally movable between vertical and horizontal positions.

11. A multi-function kitchen appliance comprising first, second, and third vertically superimposed compartments.

12. The multi-function kitchen appliance according to claim 11, wherein the first compartment is a cooking compartment, wherein the second compartment is a storage compartment, wherein the third compartment is a refrigeration compartment, and further comprising a frame and tray drawer slidably mounted to the frame for movement between a position within the frame and a position extended outward from the frame.

13. The multi-function kitchen appliance according to claim 12, further comprising a plurality of wheels enabling the kitchen cabinet to rolled with respect to a supporting surface.

14. The multi-function kitchen appliance according to claim 13, wherein the cooking compartment is slidably mounted to the frame for movement between a position within the frame and a position extended outward from the frame.

15. The multi-function kitchen appliance according to claim 14, wherein the refrigeration compartment is slidably mounted to the frame for movement between a position within the frame and a position extended outward from the frame.

16. The multi-function kitchen appliance according to claim 14, wherein cooking drawer includes a cooking surface and an shutoff switch pivotally mounted with respect to the cooking surface and being movable between a horizontal position and a vertical position.

17. The multi-function kitchen appliance according to claim 11, wherein at least one of the compartments is vertically stepped between left and right sides.

18. The multi-function kitchen appliance according to claim 17, further comprising a flexible compartment divider having a flexible element with magnets at opposing first and second ends.

19. The multi-function kitchen appliance according to claim 11, further comprising handles disposed on front surfaces of the first, second, and third compartments.

20. A cabinet kitchen comprising:
a frame:
a plurality of wheel mounted to a lower side of the frame;
a tray slidably mounted to the frame for movement within a first position nested within the frame and a second position at least partially extending from the frame;
a cooking device slidably mounted to the frame for movement within a first position nested within the frame and a second position at least partially extending from the frame, the cooking device being slidably mounted to the frame below the tray;
a storage compartment slidably mounted to the frame for movement within a first position nested within the frame and a second position at least partially extending from the frame, the storage compartment device being slidably mounted to the frame below the tray and the cooking device; and
a refrigeration compartment mounted to the frame below the storage compartment.
